(19) United States
(12) Patent Application Publication
(10) Pub. No.: US 2018/0374461 A1
(43) Pub. Date: Dec. 27, 2018

(54) SYSTEM AND METHOD FOR AUTOMATICALLY GENERATING MEDIA

(71) Applicant: ZYA, INC,, Calabasas, CA (US)

(72) Inventors: Matthew Michael Serletic, Calabasas, CA (US); Bo Bazylevsky, Calabasas, CA (US); James Mitchell, Calabasas, CA (US); Ricky Kovac, Calabasas, CA (US); Patrick Woodward, Calabasas, CA (US); Thomas Webb, Calabasas, CA (US); Ryan Groves, Montreal (CA); Ed Schofield, Calabasas, CA (US); Brett Harrison, Calabasas, CA (US)

(21) Appl. No.: 16/016,260

(22) Filed: Jun. 22, 2018

Related U.S. Application Data
(63) Continuation-in-part of application No. 15/431,521, filed on Feb. 13, 2017.
Application No. 15/431,521 is a continuation of application No. 14/834,187, filed on Aug. 24, 2015, now Pat. No. 9,570,055.
Application No. 14/834,187 is a continuation-in-part of application No. 15/986,589, filed on May 22, 2018.
Application No. 15/986,589 is a continuation-in-part of application No. 15/431,521, filed on Feb. 13, 2017.
Application No. 15/431,521 is a continuation of application No. 14/834,187, filed on Aug. 24, 2015, now Pat. No. 9,570,055.
(60) Provisional application No. 62/524,838, filed on Jun. 26, 2017.
(60) Provisional application No. 62/121,803, filed on Feb. 27, 2015.
(60) Provisional application No. 62/040,842, filed on Aug. 22, 2014.
(60) Provisional application No. 62/121,803, filed on Feb. 27, 2015.
(60) Provisional application No. 62/040,842, filed on Aug. 22, 2014.

(51) Int. Cl. G10H 1/00; G10L 25/48; H04N 9/87; H04N 9/802; G10L 13/027

(52) U.S. Cl. CPC G10H 1/0025; G10L 25/48; G10H 2250/455; G10H 2240/131; G10H 2240/085; G10H 2220/106; H04N 9/8715; G10H 2210/111; H04N 9/802; G10L 13/027

(57) ABSTRACT

A computer implemented method for automatically generating lyric videos comprising receiving an audio selection, determining timing information of the audio selection, and determining lyric information of the audio selection. The method includes receiving tone information of the audio selection and generating video content based on at least one of the timing information, the lyric information, and the tone information of the audio selection. The method also includes rendering a lyric video based on the video content and the audio selection.

### CROSS-REFERENCE TO RELATED APPLICATIONS

This application claims priority to U.S. Provisional Patent Application No. 62/524,838, filed Jun. 26, 2017. This application is a continuation-in-part of U.S. patent application Ser. No. 15/431,521, filed Feb. 13, 2017, which is a continuation of U.S. patent Ser. No. 14/834,187, filed Aug. 24, 2015, now U.S. Pat. No. 9,570,055, which claims priority to U.S. Provisional Application No. 62/121,803, filed Feb. 27, 2015, and U.S. Provisional Application No. 62/040,842, filed Aug. 22, 2014. This application is also a continuation-in-part application of U.S. patent application Ser. No. 15/986,589, filed May 22, 2018, which is a continuation-in-part of U.S. patent application Ser. No. 15/431,521, filed Feb. 13, 2017, which is a continuation of U.S. patent Ser. No. 14/834,187, filed Aug. 24, 2015, now U.S. Pat. No. 9,570,055, which claims priority to U.S. Provisional Application No. 62/121,803, filed Feb. 27, 2015, and U.S. Provisional Application No. 62/040,842, filed Aug. 22, 2014. Each of the above-listed disclosures are incorporated by reference in their entirety herein.

### TECHNICAL FIELD

The present disclosure relates generally to the field of music creation, and more specifically to a system of creating music videos.

### BACKGROUND

With the proliferation of smartphones, tablets, and other devices capable of displaying media quickly and portably, users are increasingly using those devices to create original content. Users and artists create songs, videos, and other content for themselves or others to view or otherwise experience. Lyric videos are a type of media content in which a song or other audio selection may be set to visualizations, which may include all or some of the song's lyrics displayed in time with the audio playback of the song.

It would be desirable to provide users with a system to more easily generated lyric videos and other video visualizations.

### SUMMARY

In an embodiment, the disclosure describes a computer implemented method for automatically generating lyric videos. The method may include receiving an audio selection, determining timing information of the audio selection, and determining lyric information of the audio selection. The method may include receiving tone information of the audio selection and generating video content based on at least one of the timing information, the lyric information, and the tone information of the audio selection. The method may also include rendering a lyric video based on the video content and the audio selection.

In another embodiment, the disclosure describes a computer implemented method for automatically generating lyric videos. The method may include receiving, via a digital communication network, an audio selection. The method may also include determining, via one or more processors, timing information of the audio selection. The method may include requesting, via the digital communication network, lyric information of the audio selection from a lyric database, and receiving, via the digital communication network, the lyric information of the audio selection from the lyric database based on the request. The method may also include requesting, via the digital communication network, tone information of the audio selection from a tone database, and receiving, via the digital communication network, the tone information of the audio selection from the tone database based on the request. The tone information may include at least one of a genre, a tempo, a mood, an artist, or a style corresponding to the audio selection. The method may include generating, via the one or more processors, video content based on at least one of the timing information, the lyric information, and the tone information of the audio selection. The method may also include rendering, via the one or more processors, a lyric video based on the video content and the audio selection.

In another embodiment, the disclosure describes a computer implemented method for automatically generating lyric videos. The method may include receiving, via a digital communication network, an audio selection from a user device. The method may include determining, via one or more processors, timing information of the audio selection, and determining, via the one or more processors, lyric information of the audio selection. The method may include performing, via the one or more processors, a lyric analysis on the lyric information. The method may include requesting, via the digital communication network, tone information of the audio selection from a third party database, and receiving, via the digital communication network, the tone information of the audio selection from the third party database based on the request. The tone information may include at least one of a genre, a tempo, a mood, an artist, or a style corresponding to the audio selection. The method may include generating, via the one or more processors, video content based on at least one of the timing information, the lyric analysis, and the tone information of the audio selection. The method may include rendering, via the one or more processors, at least a portion of a lyric video based on the video content and the audio selection. The method may also include transmitting, via the digital communication network, the at least portion of the lyric video to the user device for playback.

### BRIEF DESCRIPTION OF THE DRAWINGS

Non-limiting and non-exhaustive embodiments are described in reference to the following drawings. In the drawings, like reference numerals refer to like parts through all the various figures unless otherwise specified.

For a better understanding of the present disclosure, a reference will be made to the following detailed description, which is to be read in association with the accompanying drawings, wherein:

FIG. 1 illustrates one exemplary embodiment of a network configuration in which a lyric video system may be practiced in accordance with the disclosure;

FIG. 2 illustrates a flow diagram of an embodiment of a method of operating a media generation system of the lyric video system in accordance with the disclosure;

FIG. 3 illustrates a flow diagram of an embodiment of a method of operating an audio generation system of the lyric video system in accordance with the disclosure;

FIG. 4 illustrates a block diagram of a device that supports the systems and processes of the disclosure;

FIG. 5 illustrates a flow diagram of an embodiment of a method of operating an animation generation system of the lyric video system in accordance with the disclosure; and

FIG. 6 illustrates a flow diagram of an embodiment of a method of operating the lyric video system in accordance with the disclosure.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, although it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and includes plural references. The meaning of “in” includes “in” and “on.”

The present disclosure relates to a system and method for automatically creating a lyric musical video based on user inputs that may be viewed, saved, or transmitted to users via a variety of messaging formats, such as SMS, MMS, and e-mail. It may also be possible to send such musical composition messages via various social media platforms and formats, such as Twitte®, Facebook®, Instagram®, Snapchat®, or any other suitable media sharing system. In certain embodiments, the disclosed lyric video system may provide users with an intuitive and convenient way to automatically create, view, and send original lyric videos based on user inputs. For example, the lyric video system may receive a user's selection of a musical work or melody that is pre-recorded or recorded and provided by the user. The selection may be received as user selection in a variety of ways and user interfaces, such as via a keyboard or through voice recognition software. Once the user selections are received, the lyric video system can analyze and parse the selected musical work and its lyrics to create an original lyric musical video of selected or provided musical work to provide a musically-enhanced version of the text input by the user. The output of the lyric video system may automatically provide an original music video with visual representations of the music selection's lyrics based on the lyric's timing, and may include visual representations reflective of the audio selection's mood or tone. The user can then, if it chooses, share the lyrical video with others via social media, SMS or MMS messaging, or any other form of file sharing or electronic communication.

In some embodiments, the user can additionally record video to accompany the visual depictions and video output of the automatically generated lyric video. In some embodiments, the user video input may be recorded in real-time along with a vocal rendering of text input provided by the user in order to effectively match the video to the lyrics in the lyric music video created by the system. In other embodiments, the lyric video may include only automatically generated images, animations, video, and other visuals generated by the lyric video system. The result of the system, in such embodiments, may be an original lyric video created automatically for viewing on a client device such as a smartphone or tablet connected to a server via a network, and requiring little or no specialized technical skills or knowledge. In some embodiments, the client device need not be connected to a network. The lyric video system and methods of implementing such a system are described in more detail below.

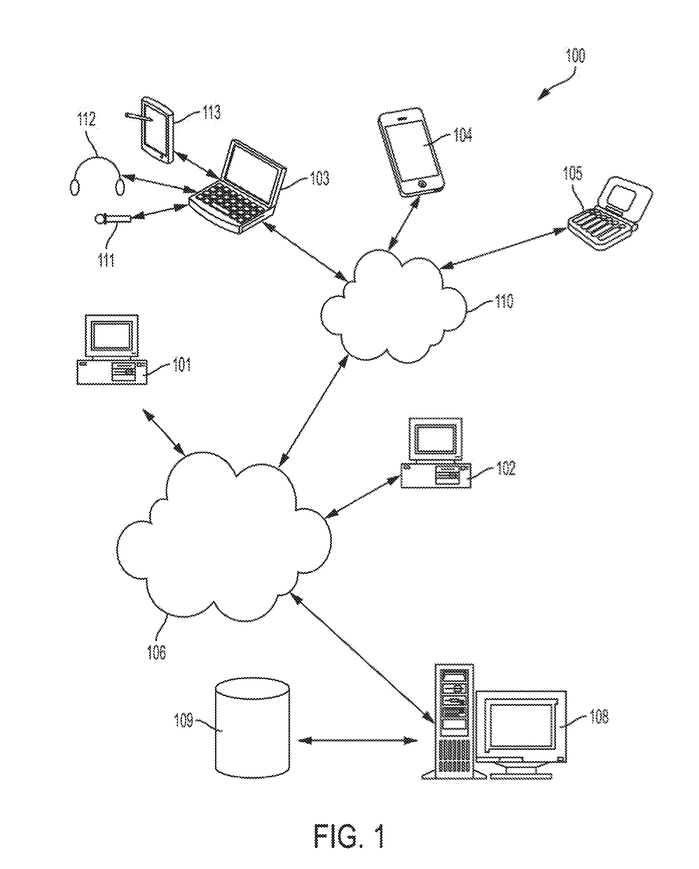

FIG. 1 illustrates an exemplary embodiment of a network configuration in which the disclosed lyric video system 100 can be implemented. It is contemplated herein, however, that not all of the illustrated components may be required to implement the lyric video system, and that variations in the arrangement and types of components can be made without departing from the spirit of the scope of the invention. Referring to FIG. 1, the illustrated embodiment of the lyric video system 100 includes local area networks (“LANs”)/wide area networks (“WANs”) (collectively network 106), wireless network 110, client devices 101-105, server 108, media database 109, and peripheral input/output (I/O) devices 111, 112, and 113. While several examples of client devices are illustrated, it is contemplated herein that client devices 101-105 may include virtually any computing device capable of processing and sending audio, video, or textual data over a network, such as network 106, wireless network 110, etc. In some embodiments, one or both of the wireless network 110 and the network 106 can be a digital communications network. Client devices 101-105 may also include devices that are configured to be portable. Thus, client devices 101-105 may include virtually any portable computing device capable of connecting to another computing device and receiving information. Such devices include portable devices, such as cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like.

Client devices 101-105 may also include virtually any computing device capable of communicating over a network to send and receive information, including track information and social networking information, performing audibly generated track search queries, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 101-105 may operate over wired and/or wireless network.

A client device 101-105 can be web-enabled and may include a browser application that is configured to receive and to send web pages, web-based messages, and the like. The browser application may be configured to receive and display graphics, text, multimedia, video, etc., and can employ virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized 25 Markup Language (SMGL), HyperText Markup Language (HTML), eXtensible Markup Language (XML), and the like, to display and send various content. In one embodiment, a user of the client device may employ the browser application to interact with a messaging client, such as a text messaging client, an email client, or the like, to send and/or receive messages.

Client devices 101-105 also may include at least one other client application that is configured to receive content from another computing device. The client application may include a capability to provide and receive multimedia content, such as textual content, graphical content, audio content, video content, etc. The client application may further provide information that identifies itself, including a type, capability, name, and the like. In one embodiment, client devices 101-105 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in, for example, a network packet or other suitable form, sent to server 108, or other computing devices. The media database 109 may be configured to store various media such as musical clips, video clips, graphics files, animation, etc., and the information stored in the media database may be accessed by the server 108 or, in other embodiments, accessed directly by other computing device through over the network 106 or wireless network 110.

Client devices 101-105 may further be configured to include a client application that enables the end-user to log into a user account that may be managed by another computing device, such as server 108. Such a user account, for example, may be configured to enable the end-user to participate in one or more social networking activities, such as submit a track or a multi-track recording or video, search for tracks or recordings, download a multimedia track or other recording, stream video or audio content, or participate in an online music community. However, participation in various networking activities may also be performed without logging into the user account.

Wireless network 110 is configured to couple client devices 103-105 and its components with network 106. Wireless network 110 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. Wireless network 110 may further include an autonomous system of terminals, gateways, routers, etc., connected by wireless radio links, or other suitable wireless communication protocols. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation, and 4G Long Term Evolution (LTE) radio access for cellular systems, WLAN, Wireless Router (WR) mesh, and other suitable access technologies. Access technologies such as 2G, 3G, 4G, 4G LTE, and future access networks may enable wide area coverage for mobile devices, such as client devices 103-105 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), etc. In essence, wireless network 110 may include virtually any wireless communication mechanism by which information may travel between client devices 103-105 and another computing device, network, and the like.

Network 106 is configured to couple network devices with other computing devices, including, server 108, client devices 101-102, and through wireless network 110 to client devices 103-105. Network 106 is enabled to employ any form of computer readable media for communicating information from one electronic device to another. Also, network 106 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 106 includes any communication method by which information may travel between computing devices.

In certain embodiments, client devices 101-105 may directly communicate, for example, using a peer to peer configuration.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

Various peripherals, including I/O devices 111-113 may be attached to client devices 101-105. For example, Multi-touch, pressure pad 113 may receive physical inputs from a user and be distributed as a USB peripheral, although not limited to USB, and other interface protocols may also be used, including but not limited to ZIGBEE, BLUETOOTH, or other suitable connections. Data transported over an external and the interface protocol of pressure pad 113 may include, for example, MIDI formatted data, though data of other formats may be conveyed over this connection as well. A similar pressure pad may alternately be bodily integrated with a client device, such as mobile devices 104 or 105. A headset 112 may be attached to an audio port or other wired or wireless I/O interface of a client device, providing an exemplary arrangement for a user to listen to playback of a composed message, along with other audible outputs of the system. Microphone 111 may be attached to a client device 101-105 via an audio input port or other connection as well. Alternately, or in addition to headset 112 and microphone 111, one or more speakers and/or microphones may be integrated into one or more of the client devices 101-105 or other peripheral devices 111-113. Also, an external device may be connected to pressure pad 113 and/or client devices 101-105 to provide an external source of sound samples, waveforms, signals, or other musical inputs that can be reproduced by external control. Such an external device may be a MIDI device to which a client device 103 and/or pressure pad 113 may route MIDI events or other data in order to trigger the playback of audio from external device. However, it is contemplated that formats other than MIDI may be employed by such an external device.

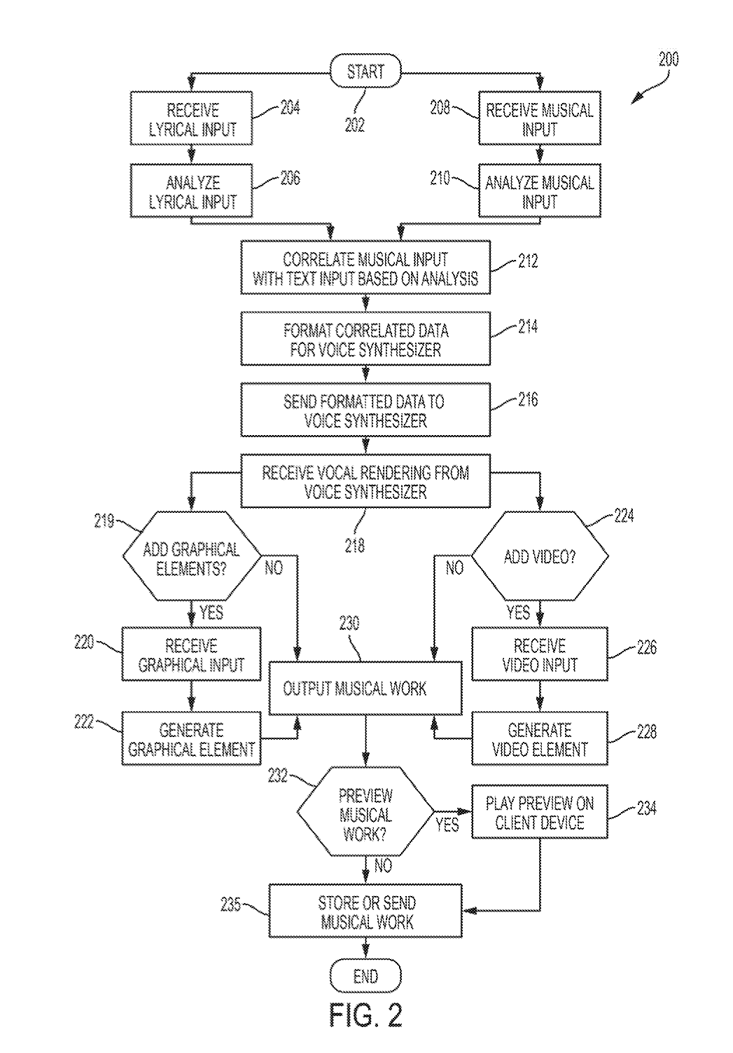

FIG. 2 is a flow diagram illustrating an embodiment of a method 200 for operating a media generation system, with references made to the components shown in FIG. 1. In some embodiments, the method 200 of operating a media generation system may be used to generate an audio selection for use with the lyric video system 100. More detail regarding the media generation system may be found in co-owned U.S. patent application Ser. No. 15/986,589, filed May 22, 2018, the disclosure of which is incorporated by reference herein. Beginning at 202, the system can receive a lyrical input at 204. The text or lyrical input may be input by the user via an electronic device, such as a PC, tablet, or smartphone, any other of the client devices 101-105 described in reference to FIG. 1 or other suitable devices. The text may be input in the usual fashion in any of these devices (e.g., manual input using soft or mechanical keyboards, touch-screen keyboards, speech-to-text conversion). In some embodiments, the text or lyrical input is provided through a specialized user interface application accessed using the client device 101-105. Alternatively, the lyrical input could be delivered via a general application for transmitting text-based messages using the client device 101-105.

The resulting lyrical input may be transmitted over the wireless communications network 110 and/or network 106 to be received by the server 108 at 204. At 206, the system may analyze the lyrical input using server 108 to determine certain characteristics of the lyrical input. In some embodiments, however, it is contemplated that analysis of the lyrical input could alternatively take place on the client device 101-105 itself instead of or in parallel to the server 108. Analysis of the lyrical input can include a variety of data processing techniques and procedures. For example, in some embodiments, the lyrical input is parsed into the speech elements of the text with a speech parser. For instance, in some embodiments, the speech parser may identify important words (e.g., love, anger, crazy), demarcate phrase boundaries (e.g., “I miss you.” “I love you.” “Let's meet.” “That was an awesome concert.”) and/or identify slang terms (e.g., chill, hang). Words considered as important can vary by region or language, and can be updated over time to coincide with the contemporary culture. Similarly, slang terms can vary geographically and temporally such that the media generation system is updatable and customizable. Punctuation or other symbols used in the lyrical input can also be identified and attributed to certain moods or tones that can influence the analytical parsing of the text. For example, an exclamation point could indicate happiness or urgency, while a “sad-face” emoticon could indicate sadness or sorrow. In some embodiments, the words or lyrics conveyed in the lyrical input can also be processed into its component pieces by breaking words down into syllables, and further by breaking the syllables into a series of phonemes. In some embodiments, the phonemes are used to create audio playback of the words or lyrics in the lyrical input. Additional techniques used to analyze the lyrical input are described in greater detail below.

At 208, the system may receive a selection of a musical input transmitted from the client device 101-105. In some embodiments, a user interface may be implemented to select the musical input from a list or library of pre-recorded and catalogued musical works or clips of musical works that may comprise one or more musical phrases. In this context, a musical phrase may be a grouping of musical notes or connected sounds that exhibits a complete musical “thought,” analogous to a linguistic phrase or sentence. To facilitate the user's choice between pre-recorded musical works or phrases, the list of available musical works or phrase may include, for example, a text-based description of the song title, performing artists, genre, and/or mood set by phrase, to name only a few possible pieces of information that could be provided to users via the user interface. Based on the list of available musical works or phrases, the user may then choose the desired musical work or clip for the media generation system to combine with the lyrical input. In one embodiment, there may be twenty or more pre-recorded and selected musical phrases for the user to choose from.

In some embodiments, the pre-recorded musical works or phrases may be stored on the server 108 or media database 109 in any suitable computer readable format, and accessed via the client device 101-105 through the wireless network 106 and/or network 110. Alternatively, in other embodiments, the pre-recorded musical works may be stored directly onto the client device 101-105 or another local memory device, such as a flash drive or other computer memory device. Regardless of the storage location, the list of pre-recorded musical works can be updated over time, removing or adding musical works in order to provide the user with new options and additional choices.

It is also contemplated that individual users may create their own melodies for use in association with the media generation system. One or more melodies may be created using the technology disclosed in U.S. Pat. No. 8,779,268 entitled “System and Method for Producing a More Harmonious Musical Accompaniment Graphical User Interface for a Display Screen System and Method that Ensures Harmonious Musical Accompaniment” assigned to the assignee of the present application. Such patent disclosure is hereby incorporated by reference, in full. In other embodiments, a user may generate a musical input using an input device 111-113, such as a MIDI instrument or other device for inputting user-created musical works or clips. For example, in some embodiments, a user may use MIDI keyboard to generate a musical riff or entire song to be used as the musical input. In some embodiments, a user may create audio recording playing notes with a more traditional, non-MIDI instrument, such as a plano or a guitar. The audio recording may then be analyzed for pitch, tempo, etc., to utilize the audio recording as the musical input.

In further embodiments, individual entries in the list of musical input options are selectable to provide, via the client device 101-105, a pre-recorded musical work (either stored or provided by the user), or a clip thereof, as a preview to the user. In such embodiments, the user interface associated with selecting a musical work includes audio playback capabilities to allow the user to listen to the musical clip in association with their selection of one of the musical works as the musical input. In some embodiments, such playback capability may be associated with a playback slider bar that graphically depicts the progressing playback of the musical work or clip. Whether the user selects the melody from the pre-recorded musical works stored within the system or from one or more melodies created by the user, it is contemplated that the user may be provided with functionality to select the points to begin and end within the musical work to define the musical input.

Once a user selects the desired musical work or clip to be used as the musical input for the user's musical work, the client device 101-105 may transmit the selection over the wireless network 106 and/or network 110, which may be received by the server 108 as the musical input at 208 of FIG. 2. At 210, the musical input may be analyzed and processed in order to identify certain characteristics and patterns associated with the musical input so as to more effectively match the musical input with the lyrical input to produce an original musical composition for use in a message or otherwise. For example, in some embodiments, analysis and processing of the musical work includes “reducing” or “embellishing” the musical work. In some embodiments, the selected musical work may be parsed for features such as structurally important notes, rhythmic signatures, and phrase boundaries. In embodiments that utilize a text or speech parser as described above, the results of the text or speech parsing may be factored into the analysis of the musical work as well. During analysis and processing, each musical work or clip may optionally be embellished or reduced, either adding a number of notes to the phrase in a musical way (embellish), or removing them (reduce), while still maintaining the idea and recognition of the original melody in the musical input. These embellishments or reductions may be performed in order to align the textual phrases in the lyrical input with the musical phrases by aligning their boundaries, and also to provide the musical material necessary for the alignment of the syllables of individual words to notes resulting in a natural musical expression of the input text. It is contemplated that, in some embodiments, all or part of the analysis of the pre-recorded musical works may have already been completed enabling the media generation system to merely retrieve the pre-analyzed data from the media database 109 for use in completing the musical composition. The process of analyzing the musical work in preparation for matching with the lyrical input and for use in the musical message is set forth in more detail below.

Subsequent to the analysis of the musical input, at 212, the lyrical input and the musical input may be correlated with one another based on the analyses of both the lyrical input and the musical input 206 and 210. Specifically, in some embodiments, the notes of the selected and analyzed musical work are intelligently and automatically assigned to one or more phonemes in the input text, as described in more detail below. In some embodiments, the resulting data correlating the lyrical input to the musical input may then be formatted into a synthesizer input at 214 for input into a voice synthesizer. The formatted synthesizer input, in the form of text syllable-melodic note pairs, may then be sent to a voice synthesizer at 216 to create a vocal rendering of the lyrical input for use in an original musical work that incorporates characteristics of the lyrical input and the musical input. The musical message or vocal rendering may then be received by the server 108 at 218. In some embodiments, the generated musical work may be received in the form of an audio file including a vocal rendering of the lyrical input entered by the user correlating with the music/melody of the musical input, either selected or created. In some embodiments, the voice synthesizer may generate the entire musical work including the vocal rendering of the lyrical input and the musical portion from the musical input. In other embodiments, the voice synthesizer may generate only a vocal rendering of the input text created based on the synthesizer input, which may be generated by analyzing the lyrical input and the musical input described above. In such embodiments, a musical rendering based on the musical input, or the musical input itself, may be combined with the vocal rendering to generate a musical work.

The voice synthesizer may be any suitable vocal renderer. In some embodiments, the voice synthesizer may be cloud-based with support from a web server that provides security, load balancing, and the ability to accept inbound messages and send outbound musically-enhanced messages. In other embodiments, the vocal renderer may be run locally on the server 108 itself or on the client device 101-105. In some embodiments, the voice synthesizer may render the formatted lyrical input data to provide a text-to-speech conversion as well as singing speech synthesis. In one embodiment, the vocal renderer may provide the user with a choice of a variety of voices, a variety of voice synthesizers (including but not limited to HMM-based, diphone or unit-selection based), or a choice of human languages. Some examples of the choices of singing voices are gender (e.g., male/female), age (e.g., young/old), nationality or accent (e.g., American accent/British accent), or other distinguishing vocal characteristics (e.g., sober/drunk, yelling/whispering, seductive, anxious, robotic, etc.). In some embodiments, these choices of voices may be implemented through one or more speech synthesizers each using one or more vocal models, pitches, cadences, and other variables that may result in perceptively different sung attributes. In some embodiments, the choice of voice synthesizer may be made automatically by the system based on analysis of the lyrical input and/or the musical input for specific words or musical styles indicating mood, tone, or genre. In certain embodiments, after the voice synthesizer generates the musical message, the system may provide harmonization to accompany the melody. Such accompaniment may be added into the message in the manner disclosed in pending U.S. Pat. No. 8,779,268, incorporated by reference above.

In some embodiments, the user may have the option of adding graphical elements to the musical work at 219. If selected, graphical elements may be chosen from a library of pre-existing elements stored either at the media database 109, on the client device 101-105 itself, or both. In another embodiment, the user may create its own graphical element for inclusion in a generated multimedia work. In yet other embodiments, graphic elements may be generated automatically without the user needing to specifically select them. Some examples of graphics that may be generated for use with the musical work may be colors and light flashes that correspond to the music in the musical work, animated figures or characters spelling out all or portions of textual message or lyrics input by the user, or other animations or colors that may be automatically determined to correspond with the tone of the musical input or with the tone of the lyrical input itself as determined by analysis of the lyrical input. If the user selects or creates a graphical element, a graphical input indicating this selection may be transmitted to and received by the server 108 at 220. The graphical element may then be generated at 222 using either the pre-existing elements selected by the user, automatic elements chosen by the system based on analysis of the lyrical input and/or the musical input, or a graphical elements provided by the user.

In some embodiments, the user may choose, at 224, to include a video element to be paired with the musical work, or to be stored along with the musical work in the same media file output. If the user chooses to include a video element, the user interface may activate one or more cameras that may be integrated into the client device 101-105 to capture video input, such as front-facing or rear-facing cameras on a smartphone or other device. In some embodiments, the user may manipulate the user interface on the client device to record video inputs to be incorporated into the generated musical. In some embodiments, the user interface displayed on the client device 101-105 may provide playback of the generated musical work while the user captures the video inputs allowing the user to coordinate particular features of the video inputs with particular portions of the musical work. In one such embodiment, the user interface may display the text of the lyrical input on the device's screen with a progress indicator moving across the text during playback so as to provide the user with a visual representation of the musical work's progress during video capture. In yet other embodiments, the user interface may allow the user to stop and start video capture as desired throughout playback of the musical work, while simultaneously stopping playback of the musical work. One such way of providing this functionality may be by capturing video while the user touches a touchscreen or other input of the client device 101-105, and at least temporarily pausing video capture when the user releases the touchscreen or other input. In such embodiments, the system may allow the user to capture certain portions of the video input during a first portion of the musical work, pause the video capture and playback of the musical work when desired, and then continue capture of another portion of the video input to correspond with a second portion of the musical work. After video capture is complete, the user interface may provide the option of editing the video input by re-capturing portions of or the entirety of the video input.

In some embodiments, once capture and editing of the video input is complete, the video input may be transmitted to and received by the server 108 for processing at 226. The video input may then be processed to generate a video element at 228, and the video element may then be incorporated into the musical work to generate a multimedia musical work. Once completed, the video element may be synced and played along with the musical work corresponding to an order in which the user captured the portions of the video input. In other embodiments, processing and video element generation may be completed on the client device 101-105 itself without the need to transmit video input to the server 108.

If the user chooses not to add any graphical or video elements to the musical work, or once the video and/or graphical elements have been generated and incorporated into the musical work to generate a multimedia work, the musical work or multimedia work may be transmitted or outputted, at 230, to the client device 101-105 over the network 110 and/or wireless network 110. In embodiments where all or most of the described steps may be executed on a single device, such as the client device 104, the musical work may be outputted to speakers and/or speakers combined with a visual display. At that point, in some embodiments, the system may provide the user with the option of previewing the musical or multimedia work at 232. If the user chooses to preview the work, the musical or multimedia work may be played at 234 via the client device 101-105 for the user to review. In such embodiments, if the user is not satisfied with the musical or multimedia work, or would like to create an alternative work for whatever reason, the user may be provided with the option to cancel the work without sending or otherwise storing, or to edit the work further. If, however, the user approves of the musical or multimedia work, or opts not to preview the work, the user may store the work as a media file, send the work as a musical or multimedia message to a selected message recipient, etc., at 235. As discussed above, the musical or multimedia work may be sent to one or more recipients using a variety of communications and social media platforms, such as SMS or MMS messaging, e-mail, Facebook®, Twitte®, and Instagram®, so long as the messaging service/format supports the transmission, delivery, and playback of audio and/or video files.

In some embodiments, a method of generating a musical work may additionally include receiving a selection of a singer corresponding to at least one voice characteristic. In some embodiments, the at least one voice characteristic may be indicative of a particular real-life or fictional singer with a particular recognizable style. For example, a particular musician may have a recognizable voice due to a specific twang, falsetto, vocal range, vibrato style, etc. When the system receives a selection of the particular singer, the at least one voice characteristic may be incorporated into the performance of the musical work. It is contemplated that, in some embodiments, the at least one voice characteristic may be included in the formatted data sent to the voice synthesizer at 216 of the method 200 in FIG. 2. However, it is also contemplated that the at least one voice characteristic may be incorporated into the vocal rendering received from the voice synthesizer.

The following provides a more detailed description of the methodology used in analyzing and processing the lyrical input and musical input provided by the user to create a musical or multimedia work. Specifically, the details provided pertain to at least one embodiment of performing steps 206 and 210-214 of the method 200 for operating the media generation system of the lyric video system 100. It should be understood, however, that other alternative methodologies for carrying out the steps of FIG. 2 are contemplated herein. It should also be understood that the media generation system can perform the following operations automatically upon receiving a lyrical input and selection of musical input from a user via the user's client device. It should further be understood that the methodology disclosed herein provides technical solutions to technical problems associated with correlating lyrical inputs with musical inputs such that the musical output of the correlation of the two inputs is matched effectively. Further, the methods and features described herein can operate to improve the functional ability of the computer or server to process certain types of information in a way that makes the computer more usable and functional than would otherwise be possible without the operations and systems described herein.

The media generation system may gather and manipulate text and musical inputs in such a way to assure system flexibility, scalability, and effectiveness. In some embodiments, collection and analysis of data points relating to the lyrical input and musical input is implemented to improve the computer and the system's ability to effectively correlate the musical and lyrical inputs. Some data points determined and used by the system in analyzing and processing a lyrical input, such as in step 206, may be the number of characters, or character count (“CC”), and the number of words, or word count (“WC”) included in the lyrical input. Any suitable method may be used to determine the CC and WC. For example, in some embodiments the system may determine WC by counting spaces between groups of characters, or by recognizing words in groups of characters by reference to a database of known words in a particular language or selection of languages. Other data points determined by the system during analysis of the lyrical input may be the number of syllables, or syllable count (“TC”) and the number of sentences, or sentence count (“SC”). TC and SC may be determined in any suitable manner, for example, by analyzing punctuation and spacing for SC, or parsing words into syllables by reference to a word database stored in the media database 109 or elsewhere. Upon receipt of the lyrical input that may be supplied by a user via the client device 101-105, the system may analyze and parses the input text to determine values such as the CC, WC, TC, and SC. In some embodiments, this parsing may be conducted at the server 108, but it is also contemplated that, in some embodiments, parsing of the input text may be conducted on the client device 101-105. In certain embodiments, during analysis, the system may insert coded start flags and end flags at the beginning and end of each word, syllable, and sentence to mark the determination made during analysis. The location of a start flag at the beginning of a sentence, for example, may be referred to as the sentence start (“SS”), and the location of the end flag at the end of a sentence may be referred to as the sentence end (“SE”). Additionally, it is contemplated that, during analysis, words or syllables of the lyrical input may be flagged for a textual emphasis. The system methodology for recognizing such instances in which words or syllables should receive textual emphasis may be based on language or be culturally specific.

In some embodiments, another analysis conducted by the system on the input text may be determining the phrase class (“PC”) of each of the CC and the WC. The phrase class of the character count will be referred to as the CCPC and the phrase class of the word count will be referred to as the WCPC. The value of the phrase class may be a sequentially indexed set of groups representing increasing sets of values of CC or WC. For example, a lyrical input with CC of 0 may have a CCPC of 1, and a lyrical input with a WC of 0 may have a WCPC of 1. Further, a lyrical input with a CC of between 1 and 6 may have a CCPC of 2, and a lyrical input with a WC of 1 may have a WCPC of 2. The CCPC and WCPC may then increase sequentially as the CC or the WC increases, respectively.

Below, Table 1 illustrates, for exemplary and non-limiting purposes only, a possible classification of CCPC and WCPC based on CC and WC in a lyrical input.

TABLE 1

| PC | CC | WC | Description |
|---|---|---|---|
| 1 | 0 | 0 | No Lyrical input |
| 2 | 1-6 | 1 | One Word |
| 3 | 7-9 | 2-3 | Extremely Short |
| 4 | 10-25 | 4-8 | Short |
| 5 | 25-75 | 9-15 | Medium |
| 6 | 75-125 | 15-20 | Long |
| 7 | 125+ | 20+ | Extremely Long |

Based on the CCPC and WCPC, the system may determine an overall phrase class for the entire lyrical input by the user, or the user phrase class (“UPC”). This determination may be made by giving different weights to different values of CCPC and WCPC, respectively. In some embodiments, greater weight may be given to the WCPC than the CCPC in determining the UPC, but it should be understood that other or equal weights may also be used. One example gives the CCPC a 40% weight and the WCPC a 60% weight, as represented by the following equation:

UPC=0.4(CCPC)+0.6(WCPC) EQ. 1

Thus, based on the exemplary Table 1 of phrase classes and exemplary equation 1 above, a lyrical input with a CC of 27 and a WC of 3 may have a CCPC of 5 and a WCPC of 3, resulting in a UPC of 3.8 as follows:

UPC=0.4(5)+0.6(3)=3.8 EQ. 2

It should be noted that the phrase class system and weighting system explained herein m variable based on several factors related to the selected musical input such as mood, genre, style, etc., or other factors related to the lyrical input, such as important words or phrases as determined during analysis of the lyrical input.

In an analogous manner, the musical input selected or provided by the user may be parsed during analysis and processing, such as in step 210 of FIG. 2. In some embodiments, the system may parse the musical input selected or provided by the user to determine a variety of data points. One data point determined in the analysis may be the number of notes, or note count (“NC”) in the particular musical input.

Another product of the analysis that may be done on the musical input may include determining the start and end of musical phrases throughout the musical input. A musical phrase may be analogous to a linguistic sentence in that a musical phrase is a grouping of musical notes that conveys a musical thought. Thus, in some embodiments, the analysis and processing of the selected musical input may involve flagging the beginnings and endings of each identified musical phrase in a musical input. Analogously to the phrase class of the of the lyrical input (UPC) described above, a phrase class of the source musical input, referred to as source phrase class (“SPC”) may be determined, for example, based on the number of musical phrases and note count identified in the musical input.

The beginning of each musical phrase may be referred to as the phrase start (“PS”), and the ending of each musical phrase may be referred to as the phrase end (“PE”). The PS and the PE in the musical input may be analogous to the sentence start (SS) and sentence end (SE) in the lyrical input. In some embodiments, the PS and PE associated with the preexisting musical works may be pre-recorded and stored on the server 108 or the client device 101-105, where they may be available for selection by the user as a musical input. In such embodiments, the locations of PS and PE for the musical input may be pre-determined and analysis of the musical input involves retrieving such information from a store location, such as the media database 109. In other embodiments, however, or in embodiments where the musical input is provided by the user and not pre-recorded and stored, further analysis is conducted to distinguish musical phrases in the musical input and, thus, determine the corresponding PS and PE for each identified musical phrase.

In some embodiments, the phrase classes of the lyrical input and the musical input are compared to determine the parity or disparity between the two inputs. It should be understood that, although the disclosure describes comparing corresponding lyrical inputs and musical inputs using phrase classes, other methodologies for making comparisons between lyrical inputs and musical inputs are contemplated herein. The phrase class comparison can take place upon correlating the musical input with the lyrical input based on the respective analyses, such as at step 212.

In certain embodiments, parity between a lyrical input and a musical input is analyzed by determining the phrase differential (“PD”) between corresponding lyrical inputs and musical inputs provided by the user. One example of determining the PD is by dividing the user phrase class (UPC) by the source phrase class (SPC), as shown in Equation 3, below:

PD=UPC/SPC EQ. 3

In this example, perfect phrase parity between the lyrical input and the musical input would result in a PD of 1.0, where the UPC and the SPC are equal. If the lyrical input is “shorter” than the musical input, the PD may have a value less than 1.0, and if the lyrical input is “longer” than the musical input, the PD may have a value of greater than 1.0. Those with skill in the art will recognize that similar results could be obtained by dividing the SPC by the UPC, or with other suitable comparison methods.

Parity between the lyrical input and the musical input may also be determined by the “note” differential (“ND”) between the lyrical input and the musical input provided by the user. One example of determining the ND is by taking the difference between the note count (NC) and the analogous syllable count (TC) of the lyrical input. For example:

ND=NC−TC EQ. 4

In this example, perfect phrase parity between the lyrical input and the musical input would be an ND of 0, where the NC and the TC are equal. If the lyrical input is “shorter” than the musical input, the ND may be greater than or equal to 1, and if the lyrical input is “longer” than the musical input, the ND may be less than or equal to −1. Those with skill in the art will recognize that similar results could be obtained by subtracting the NC from the TC, or with other suitable comparison methods.

Using these or suitable alternative comparison methods establishes how suitable a given lyrical input is for a provided or selected musical input. Phrase parity of PD=1 and ND=0 may represent a high level of parity between the two inputs, where PD that is much greater or less than 1 or ND that is much greater or less than zero may represent a low level of parity, i.e., disparity. In some embodiments, when correlating the musical input and the lyrical input to create a musical work, the sentence starts (SS) and sentence ends (SE) of the lyrical input may align with the phrase starts (PS) and phrase ends (PE), respectively, of the musical input if the parity is perfect or close to perfect (i.e., high parity). However, when parity is imperfect, the SE and the PE may not align well when the SS and the PS are set aligned to one another. Based on the level of parity/disparity determined during analysis, various methods of processing the musical input and the lyrical input can be utilized to provide an optimal outcome for the musical work. In some embodiments, these techniques or editing tools may be applied automatically by the system, or may be manually applied by a user.

One example of a solution to correlate text and musical inputs is syllabic matching. When parity is perfect, i.e., note differential (ND) is zero, the note count (NC) and the syllable count (TC) are equal or the phrase differential (PD) is 1.0, syllabic matching can involve simply matching the syllables in the text input to the notes in the musical input and/or matching the text input sentences to the musical input musical phrases.

In some embodiments, however, if PD is slightly greater than or less than to 1.0 and/or ND is between, for example, 1 and 5 or −1 and −5, melodic reduction or embellishment, respectively, can be used to provide correlation between the inputs. Melodic reduction involves reducing the number of notes played in the musical input and can be used when the NC is slightly greater than the TC (e.g., ND is between approximately 1 and 5) or the musical source phrase class (SPC) is slightly greater than the user phrase class (UPC) (e.g., PD is slightly less than 1.0). Reducing the notes in the musical input can shorten the overall length of the musical input and result in the NC being closer to or equal to the TC of the text input, increasing the phrase parity. The fewer notes that are removed from the musical input, the less impact the reduction will have on the musical work selected as the musical input and, therefore, the more recognizable the musical element of the musical message will be upon completion. Similarly, melodic embellishment involves adding notes to (i.e., “embellishing”) the musical input. In some embodiments, melodic embellishment is used when the NC is slightly less than the TC (e.g., ND is between −1 and −5) or the SPC is slightly less than the UPC (e.g., PD is slightly greater than 1.0). Adding notes in the musical input can lengthen the musical input, which can add to the NC or SPC and, thus, increase the parity between the inputs. The fewer notes that are added using melodic embellishment, the less impact the embellishment will have on the musical work selected as the musical input and, therefore, the more recognizable the musical element of the musical message will be upon completion. In some embodiments, the additional notes added to the musical work are determined by analyzing the original notes in the musical work and adding notes that make sense musically. For example, in some embodiments, the system may only add notes in the same musical key as the original musical work, or notes that maintain the tempo or other features of the original work so as to aide in keeping the musical work recognizable. It should be understood that although melodic reduction and embellishment have been described in the context of slight phrase disparity between the musical and text inputs, use of melodic reduction and embellishment in larger or smaller phrase disparity is also contemplated.

A system for audio generation may be used by or in conjunction with the lyric video system. In such embodiments, generally, the system may receive timing information from multiple sources, but may ultimately be converted into MIDI and MusicXML data, or other suitable data formats. A performance of the timing data may be created at a stage where the system mimics a human technician by slightly adjusting pitch and timing information to match the original intent of the timing source, i.e. a song or other audio recording. The system may then determine an appropriate voice model based on inputs associated with the timing data. The inputs may be a music artist name, title of the work, gender of the speaker, musical key, etc. In some embodiments, the performance may be converted into a suitable data format along with the MusicXML and a voice model ID. Together, these inputs may be transmitted to a synthesis stage, which may outputs vocal audio.

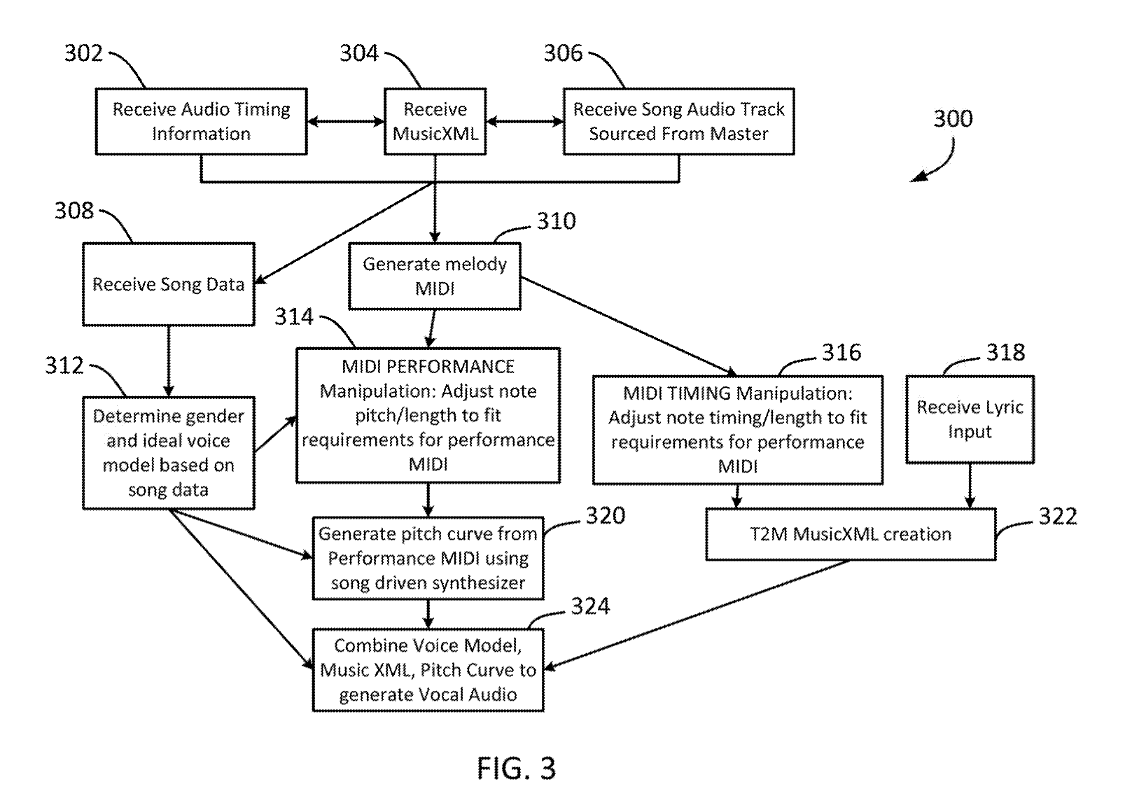

FIG. 3 shows flow chart of an embodiment of a method for audio generation 300 that may be used in conjunction with the lyric video system. The system may receive audio timing information at 302, receive digital sheet music, such as in MusicXML format at 304, or receive song audio track sourced from a master or other recording source at 306 for a particular audio selection. In each case, the received data may be converted to or remain as MusicXML data, for example, or another suitable digital format. At 308, the system may receive song data, such as the artist, genre, tempo, song title, key, tone, etc. At 312, the system may determine a vocalist gender, style, or ideal voice model based on the received song data. At 310, the system may generate MIDI data for the audio selection based on the MusicXML data. At 314, based on the MIDI and ideal voice model determination at 310 and 312, the system may conduct MIDI performance manipulation. For example, in some embodiments, the system may adjust the pitch or the length of a note to fit requirements for a performance MIDI based on the voice data and the song data. At 316, the system may conduct MIDI timing manipulation. For example, the system may adjust note timing/length to fit requirements for a performance MIDI base on the ideal voice model, song data, etc. At 318, the system may receive a lyric input, which may be received from a local or third party lyric database or from a user input. At 322, the system may generate a text-to-music MusicXML based on the lyric input from 318 and the MIDI timing information from 316. Further detail on methods by which lyrical text data may be matched with music or musical input data are described above, and further in co-pending U.S. patent application Ser. No. 15/986,589. At 320, the system may generate a pitch curve based on the MIDI performance manipulation result in 314 and the ideal voice model data from 312 using, for example, a song driven synthesizer. At 324, vocal audio may be generated based on the ideal voice model data from 312, the text-to-music MusicXML generated at 322, and the pitch curve from 320.

In some embodiments, the lyric video system may utilize the methods as described above with reference to FIG. 2 and the media generation system or FIG. 3 and the audio generation system as the audio selection for the lyric video system 100. In other embodiments, the audio selection may be a pre-recorded song, either by the user, a third party, or may be a commercially available song or other piece of audio. For example, the audio selection may be selected from a third-party music database, such as Apple iTunes® Store, Spotify®, Amazon Music®, or any other third-party database. The audio selection may be a song or audio file stored on a user device 101-105, or stored on a third-party remote server or cloud platform accessible via the Internet or other network.

Regardless of the audio selection's source, an animation generation system of the lyric video system may generate a digital movie file that may include, for example, a video with lyric animations. In some embodiments, the animation generation system may begin with the same or similarly sourced timing data as used in the audio generation system described with regard to FIG. 3. Based on a lyric input, along with the timing data, the system may ultimately generate a visual animation that may be paired with a digital movie file audio to complete a final digital movie file. In some embodiments, the lyric input may be analyzed for logical breaks like stanzas or song sections. Examples of this type of textual analysis are described above and further with regard to co-pending U.S. patent application Ser. No. 15/986,589, incorporated by reference herein. Based on this analysis, the system may insert animations onto the determined stanzas or song sections, or on identified key words in the lyric input. In some embodiments, information about the lyric input may be shared with a third party system to retrieve additional information that may help the system determine a color palette, imagery and animations suitable to the song or lyrics. In some embodiments, themed animation pools may be introduced and selected based on genre, mood, tempo and text/word length. Finally, in some embodiments, the animation may be rendered in real time as the system receives information. The audio and animation may then be combined to render a final digital movie file.

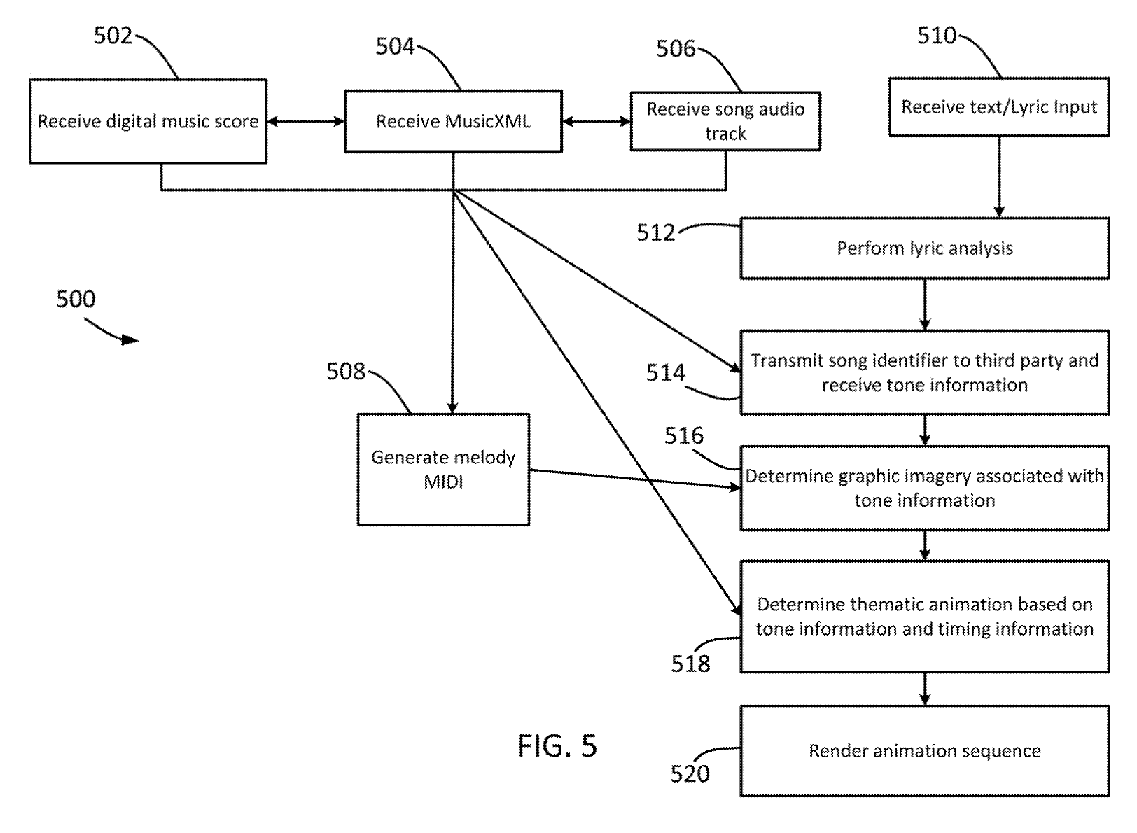

FIG. 5 shows an embodiment of a method 500 for using the animation generation system of the lyric video system. At 502, the system may receive a digital music score of an audio selection. In some embodiments, the digital music score may be received from a third-party repository, such as a sheet music warehouse, or other database. In other embodiments, the digital score may be store in a local system database, cloud storage, or on a user device. At 504, in some embodiments, the system may receive MusicXML data directly as the audio input, for example, from a MusicXML warehouse or other database. At 506, in some embodiments, the system may receive a song audio track sourced from a master or from any suitable source, including cloud streaming services, third-party databases, local storage, etc. In any of 502 or 506, a MusicXML or other suitable data format may be generated from the digital sheet music or from the song audio track. Based on any of 502, 504, and 506, the system may generate a melody MIDI at 508. In some embodiments, the melody MIDI may include timing and pitches of the lead vocal in the audio selection based on timing information included in the audio selection either in the MusicXML format or otherwise. At 510, the system may receive a lyric input that may be the text of the lyrics in the audio selection. In some embodiments, the lyric input may be the words to a third party song, or it may be the text input for lyrics provided by a user during the process described above with reference to FIG. 2. In any event, at 512, the system may conduct a lyric analysis to generate a lyric timeline and assign lyric features based on the analysis. In some embodiments, lyric features may include analyzing the specific words in a lyrical input and assigning colors, images, animation, or other graphical or video features based on the meanings or context of the words. For example, if the lyric input includes the word “love,” the lyric analysis may assign the color red to the word, stanza, verse, or section of the audio selection containing the word. In other embodiments, the system may assign certain imagery or animation based on certain other keywords or repeated words in the lyric input.

At 514, the system may transmit a song or audio selection identifier to a third party database or index based on information in the MusicXML or the audio selection identification more generally. The system may then receive tone information about the audio selection. For example, the third party database may transmit tone information including the genre, mood, tempo, tone, style, significance, situational grouping information of artist or song, etc., which may be received by the system. In some embodiments, the tone information may be readily available on locally on a user device or cloud, or may be from a third party. The system may determine graphic imagery that matches with or is otherwise most appropriate based on the tone information from 514, and may match the graphic imagery to the timing of the lead vocals generated in the melody MIDI at 508. The graphic imagery may be, for example, color palette, animations, or other imagery reflecting specific moods, tones, or contexts of the audio selection. At 518, the system may determine thematic animation to be incorporated into a lyric video based on the tone information received in 514 and the timing information. In some embodiments, the thematic animation may be selected from Java Script Object Notation (JSON) thematic animation pools, which may be determined based on genre, mood, tempo, and situational grouping and based on the word length determined in the timing data. At 520, in some embodiments, the system may render an animation sequence for the audio selection to generate a lyric video. In some embodiments, the animation may be generated in real time, allowing for almost immediate playback and viewing by a user. In such embodiments, the system may perform the analysis of FIG. 5 on a verse by verse or section by section basis so the lyric video may begin playback before the entire audio selection may be rendered. In other embodiments, the system may render an entire audio selection before playback, and preserve the lyric video for selective playback by a user.

The lyric video may include color background determined based on tone information, lyric analysis, and timing information received or determined by the system. During playback of the lyric video, visual depictions of the words that make up the lyrics of an audio selection may flash across the screen as they are performed in the audio selection playback. The words may be depicted in varying fonts, styles, colors, and animations that grow, shrink, move, or are otherwise adjusted and varied as a result of the analysis in FIG. 5. The lyric video may also include background colors that change, shift, or flash according to the analysis in method 500. Further, the lyric video may include themed animations selected to correspond with themes of the music, genre, lyrics, tone, etc., of the audio selection. Thus, based on receiving an audio selection from a user, the system may generate an original lyric video.

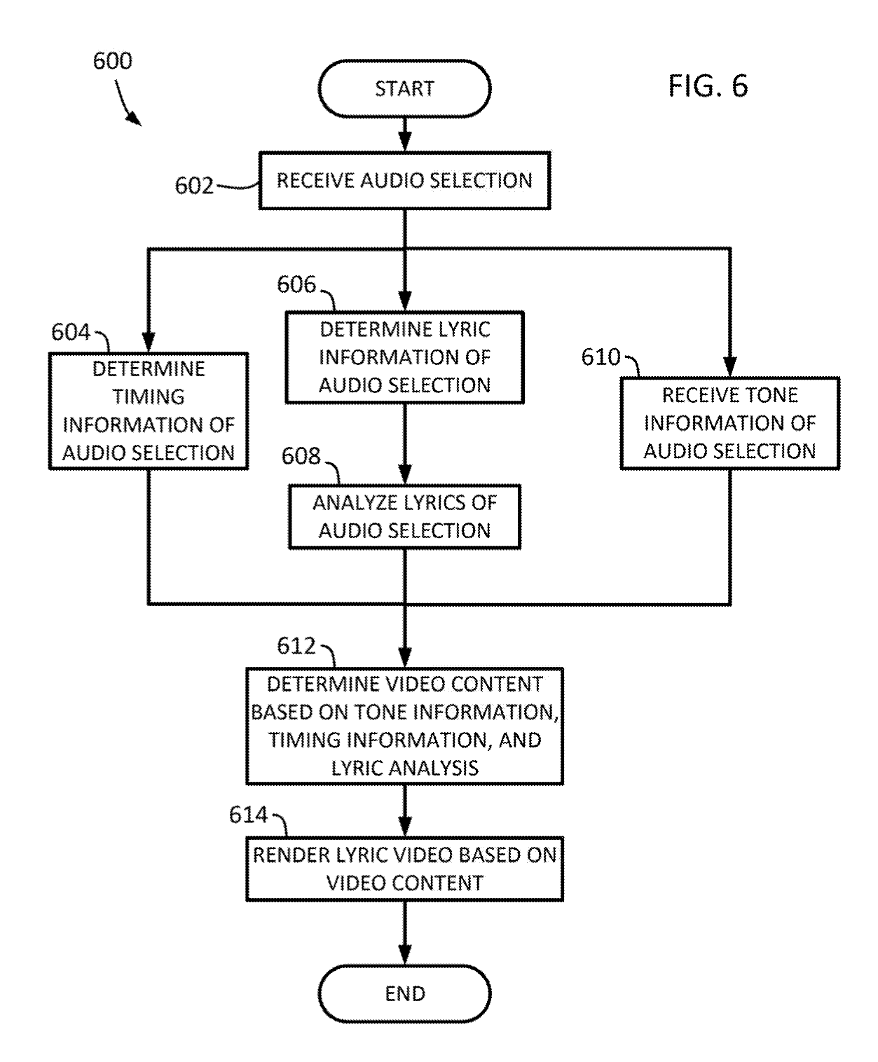

FIG. 6 shows a flow chart of another embodiment of a method 600 of using the lyric video system. At 602, the system may receive an audio selection from a user, e.g., via a user device either locally or via a network. In some embodiments, the user may select the audio selection from a list, or may input the audio selection through a search or other input. In some embodiments, the audio selection may be selected in a third party application or database, such as the Apple iTunes Store®, Amazon Music®, or Spotify®. In some embodiments, the system may receive the audio selection via a song ID or other suitable notification or identification. In some embodiments, the audio selection may be played in real time and captured by the system. Upon receiving the audio selection, the system may, at 604, determine timing information of the audio selection. In some embodiments, the timing information may be received along with the audio selection. In some embodiments, the timing information may be determined by querying a local or third party database, such as a digital sheet music database or MusicXML database. Among other things, the timing information of the audio selection may include lyric timing, such as when each word or syllable is played/sung in the song, and note timing. In some embodiments, parsing of the audio selection using methods described above with reference to FIG. 2 may be implemented to determine at least portions of the timing information. In some embodiments, a MIDI file may be generated based on the timing information and/or MusicXML data of the audio selection.

At 606, the system may determine lyric information of the audio selection, i.e., the words used or sung in the audio selection. In some embodiments, the lyric information may be determined via digital sheet music, a lyric database (either third party or local), or another suitable lyric source. In some embodiments, the system may identify the lyric information using voice recognition, such as by converting the spoken or sung words in the audio selection into text. This conversion may be done by the system itself or by using third party sources and received back into the system for analysis. At 608, the system may analyze the lyric information of the audio selection. For example, the system may determine keywords among the lyric information that indicates the style, mood, or often repeated terms. The system may also identify words commonly indicating particular moods or genres. During the lyric analysis, the system may create a timeline that assigns colors to verses or stanzas of the lyrics based on the lyric analysis. In some embodiments, the lyric analysis may include inserting particular imagery and/or animations associated with particular lyrics, phrases, verses, or stanzas. In some embodiments, parsing of the audio selection using methods described above with reference to FIG. 2 may be implemented to conduct at least portions of the lyric analysis. At 610, the system may receive tone information of the audio selection. In some embodiments, the system may include a database of songs and the associated genre, mood, tempo, situational grouping, artist, style, etc. In other embodiments, the system may transmit the audio selection (via song ID or otherwise) to a third party database or application, requesting tone information of the audio selection. In such embodiments, the system may then receive tone information from the third party database or application, such as genre, mood, tempo, situational grouping, artist, style, etc.

At 612, the system may determine video content for a lyric video based one or all of the timing information, the lyric analysis and lyric information, and the tone information. The video content automatically selected by the system may be at least partially determined by the tone information. For example, if the tone information is determined to be upbeat, happy, in a major key, etc., the system may select animation or graphics from a thematic animation pool that includes happy, upbeat visualizations with bright colors. In another example, if the tone information is determined to be somber, slow, in a minor key, etc., the system may select corresponding animation or graphics that sad or slow with more dark or drab colors to match the tone. One of ordinary skill in the art would understand that matching the color palette, animation, and imagery based on the tone information may be done in several different ways based on cultural norms or musical and video standards. In some embodiments, the video content may also be selected at least partially based on the timing information of the audio selection. For example, the visualizations chosen and the timing of the visualizations in the video content may be based on word length and timing of the lyrics. In some embodiments, system may match a graphic or image in the video content to be displayed for the length of a particular word in the lyrics, and to be removed or replaced with another graphic or animation once the lyric is finished. In some embodiments, the video content selection or determination may be based at least partially on the lyric analysis. For example, the system may determine that particular lyrics may be commonly associated with particular visualizations or animations, such as the word “love” being associated with hearts or flowers, or other associations. At 614, the system may render the lyric video or portions of the lyric video based on the video content. In some embodiments, the lyric video may be a video file including audio of the audio selection played along with the video content determined by the system. The video content may include animations, graphics, imagery and other visualizations along with visual depictions of the audio selection's lyrics. The lyrics may be displayed in the lyric video with timing that matches the occurrence of those lyrics in the playback of the audio selection. In some embodiments, the visual depiction of the lyrics may be moving, varying fonts or sizes depending on the analysis done above, or varying colors to fit the tone information, lyric analysis, and timing information. In some embodiments, however, the lyrics themselves may not be displayed in the video content, or sometimes just certain lyrics will be selected for visualization. In some embodiments, the graphics, animation, or other visualizations of the video content may be correlated to the timing of the audio selection, such as to the beat, tempo, lyric timing, etc. In some embodiments, the lyric video may be rendered all at once and saved as a video file that may be played back or transferred to another user or device. In some embodiments, the system may render the lyric video in substantially real time, lyric by lyric, verse by verse, phrase by phrase, or section by section of the audio selection. In such embodiments, playback of the lyric video may be possible before the system has finished rendering video content for the entire audio selection.

In some embodiments, the system may apply machine learning techniques or other automatic analysis to determine timing information, lyric information and analysis, and tone information without the need to receive information from third party sources. For example, in such an embodiment, the system may receive an audio selection or input, automatically derive lyrics, timing information, lyric analysis, and tone information using reference databases and machine learning techniques. The system may then select video content based on the derived information and render the lyric video accordingly.

One skilled in the art would understand that the lyric video system and the method for operating such lyric video system described herein could be performed on a single client device, such as client device 104 or server 108, or could be performed on a variety of devices, each device including different portions of the system and performing different portions of the method. For example, in some embodiments, the client device 104 or server 108 could perform most of the steps illustrated in FIG. 2, but the voice synthesis could be performed by another device or another server. The following includes a description of one embodiment of a single device that could be configured to include the lyric video system described herein, but it should be understood that the single device could alternatively be multiple devices.

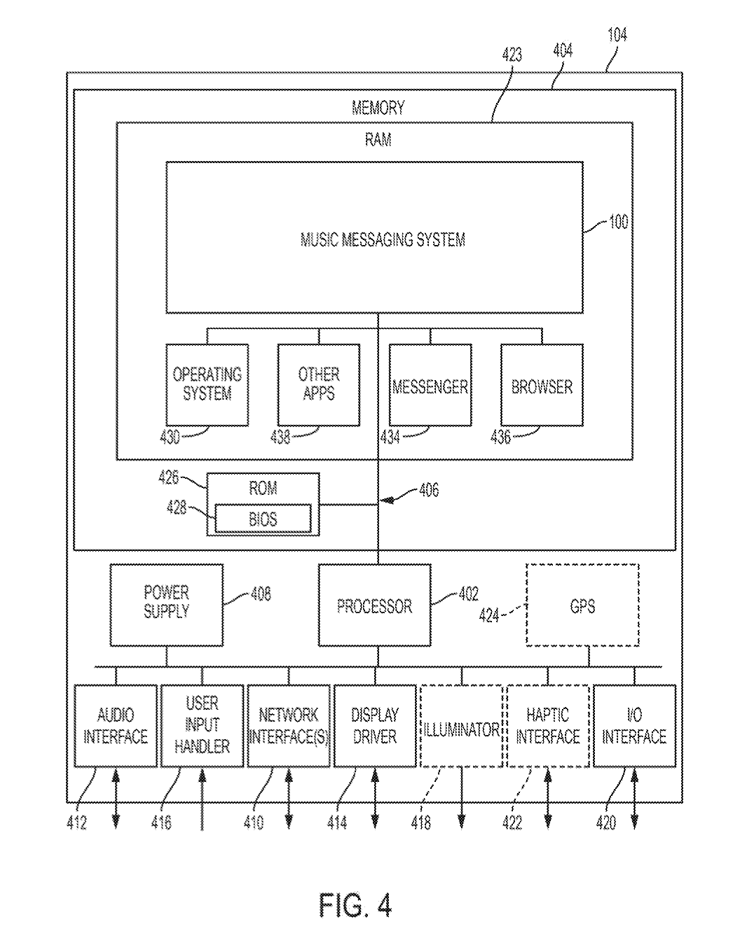

FIG. 4 shows one embodiment of the system 100 that may be deployed on any of a variety of devices 101-105 or 108 from FIG. 1, or on a plurality of devices working together, which may be, for illustrative purposes, any multi-purpose computer (101, 102), hand-held computing device (103-105) and/or server (108). For the purposes of illustration, FIG. 4 depicts the system 100 operating on device 104 from FIG. 1, but one skilled in the art would understand that the system 100 may be deployed either as an application installed on a single device or, alternatively, on a plurality of devices that each perform a portion of the system's operation. Alternatively, the system may be operated within an http browser environment, which may optionally utilize web-plug in technology to expand the functionality of the browser to enable functionality associated with system 100. Device 104 may include many more or less components than those shown in FIG. 4. However, it should be understood by those of ordinary skill in the art that certain components are not necessary to operate system 100, while others, such as processor, video display, and audio speaker are important to practice aspects of the present invention.

As shown in FIG. 4, device 104 includes a processor 402, which may be a CPU, in communication with a mass memory 404 via a bus 406. As would be understood by those of ordinary skill in the art having the present specification, drawings and claims before them, processor 402 could also comprise one or more general processors, digital signal processors, other specialized processors and/or ASICs, alone or in combination with one another. Device 104 also includes a power supply 408, one or more network interfaces 410, an audio interface 412, a display driver 414, a user input handler 416, an illuminator 418, an input/output interface 420, an optional haptic interface 422, and an optional global positioning systems (GPS) receiver 424. Device 104 may also include a camera, enabling video to be acquired and/or associated with a particular musical message. Video from the camera, or other source, may also further be provided to an online social network and/or an online music community. Device 104 may also optionally communicate with a base station or server 108 from FIG. 1, or directly with another computing device. Other computing device, such as the base station or server 108 from FIG. 1, may include additional audio-related components, such as a professional audio processor, generator, amplifier, speaker, XLR connectors and/or power supply.

Continuing with FIG. 4, power supply 408 may comprise a rechargeable or non-rechargeable battery or may be provided by an external power source, such as an AC adapter or a powered docking cradle that could also supplement and/or recharge the battery. Network interface 410 includes circuitry for coupling device 104 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Accordingly, network interface 410 may include as a transceiver, transceiving device, or network interface card (NIC).

Audio interface 412 (FIG. 4) is arranged to produce and receive audio signals such as the sound of a human voice. Display driver 414 (FIG. 4) is arranged to produce video signals to drive various types of displays. For example, display driver 414 may drive a video monitor display, which may be a liquid crystal, gas plasma, or light emitting diode (LED) based-display, or any other type of display that may be used with a computing device. Display driver 414 may alternatively drive a hand-held, touch sensitive screen, which would also be arranged to receive input from an object such as a stylus or a digit from a human hand via user input handler 416.

Device 104 also comprises input/output interface 420 for communicating with external devices, such as a headset, a speaker, or other input or output devices. Input/output interface 420 may utilize one or more communication technologies, such as USB, infrared, Bluetooth™, or the like. The optional haptic interface 422 is arranged to provide tactile feedback to a user of device 104. For example, in an embodiment, such as that shown in FIG. 1, where the device 104 is a mobile or handheld device, the optional haptic interface 422 may be employed to vibrate the device in a particular way such as, for example, when another user of a computing device is calling.

Optional GPS transceiver 424 may determine the physical coordinates of device 101 on the surface of the Earth, which typically outputs a location as latitude and longitude values. GPS transceiver 424 can also employ other geo-positioning mechanisms, including, but not limited to, triangulation, assisted GPS (AGPS), E-OTD, CI, SAI, ETA, BSS or the like, to further determine the physical location of device 104 on the surface of the Earth. In one embodiment, however, mobile device may, through other components, provide other information that may be employed to determine a physical location of the device, including for example, a MAC address, IP address, or the like.

As shown in FIG. 4, mass memory 404 includes a RAM 423, a ROM 426, and other storage means. Mass memory 404 illustrates an example of computer readable storage media for storage of information such as computer readable instructions, data structures, program modules, or other data. Mass memory 404 stores a basic input/output system (“BIOS”) 428 for controlling low-level operation of device 104. The mass memory also stores an operating system 430 for controlling the operation of device 104. It will be appreciated that this component may include a general purpose operating system such as a version of MAC OS, WINDOWS, UNIX, LINUX, or a specialized operating system such as, for example, Xbox 360 system software, Wii IOS, Windows Mobile™, iOS, Android, webOS, QNX, or the Symbian® operating systems. The operating system may include, or interface with, a Java virtual machine module that enables control of hardware components and/or operating system operations via Java application programs. The operating system may also include a secure virtual container, also generally referred to as a “sandbox,” that enables secure execution of applications, for example, Flash and Unity.

One or more data storage modules may be stored in memory 404 of device 104. As would be understood by those of ordinary skill in the art having the present specification, drawings, and claims before them, a portion of the information stored in data storage modules may also be stored on a disk drive or other storage medium associated with device 104. These data storage modules may store multiple track recordings, MIDI files, WAV files, samples of audio data, and a variety of other data and/or data formats or input melody data in any of the formats discussed above. Data storage modules may also store information that describes various capabilities of system 100, which may be sent to other devices, for instance as part of a header during a communication, upon request or in response to certain events, or the like. Moreover, data storage modules may also be employed to store social networking information including address books, buddy lists, aliases, user profile information, or the like.

Device 104 may store and selectively execute a number of different applications, including applications for use in accordance with system 100. For example, application for use in accordance with system 100 may include Audio Converter Module, Recording Session Live Looping (RSLL) Module, Multiple Take Auto-Compositor (MTAC) Module, Harmonizer Module, Track Sharer Module, Sound Searcher Module, Genre Matcher Module, and Chord Matcher Module. The functions of these applications are described in more detail in U.S. Pat. No. 8,779,268, which has been incorporated by reference above.

The applications on device 104 may also include a messenger 434 and browser 436. Messenger 434 may be configured to initiate and manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 434 may be configured as an IM messaging application, such as AOL Instant Messenger, Yahoo! Messenger, .NET Messenger Server, ICQ, or the like. In another embodiment, messenger 434 may be a client application that is configured to integrate and employ a variety of messaging protocols. In one embodiment, messenger 434 may interact with browser 436 for managing messages. Browser 436 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages, including Python, Java, and third party web plug-ins, may be employed.

Device 104 may also include other applications 438, such as computer executable instructions which, when executed by client device 104, transmit, receive, and/or otherwise process messages (e.g., SMS, MIMS, IM, email, and/or other messages), audio, video, and enable telecommunication with another user of another client device. Other examples of application programs include calendars, search programs, email clients, IM applications, SMS applications, VoIP applications, contact managers, task managers, transcoders, database programs, word processing programs, security applications, spreadsheet programs, games, search programs, and so forth. Each of the applications described above may be embedded or, alternately, downloaded and executed on device 104.

Of course, while the various applications discussed above are shown as being implemented on device 104, in alternate embodiments, one or more portions of each of these applications may be implemented on one or more remote devices or servers, wherein inputs and outputs of each portion are passed between device 104 and the one or more remote devices or servers over one or more networks. Alternately, one or more of the applications may be packaged for execution on, or downloaded from a peripheral device.

The foregoing description and drawings merely explain and illustrate the invention and the invention is not limited thereto. While the specification is described in relation to certain implementation or embodiments, many details are set forth for the purpose of illustration. Thus, the foregoing merely illustrates the principles of the invention. For example, the invention may have other specific forms without departing from its spirit or essential characteristic. The described arrangements are illustrative and not restrictive. To those skilled in the art, the invention is susceptible to additional implementations or embodiments and certain of these details described in this application may be varied considerably without departing from the basic principles of the invention. It will thus be appreciated that those skilled in the art will be able to devise various arrangements which, although not explicitly described or shown herein, embody the principles of the invention and, thus, within its scope and spirit.

What is claimed is:

1. A computer implemented method for automatically generating lyric videos, the method comprising:
receiving an audio selection;
determining, via one or more processors, timing information of the audio selection;
determining, via the one or more processors, lyric information of the audio selection;
receiving tone information of the audio selection;
generating, via the one or more processors, video content based on at least one of the timing information, the lyric information, and the tone information of the audio selection; and
rendering, via the one or more processors, a lyric video based on the video content and the audio selection.

2. The method of claim 1, further comprising transmitting a request to a third party database, where the request includes a song identification of the audio selection, and wherein receiving the tone information of the audio selection includes receiving the tone information from the third party database based on the request.

3. The method of claim 1, further comprising receiving the tone information from a third party database.

4. The method of claim 1, further comprising transmitting the lyric video to a user device via a digital communication network.

5. The method of claim 1, further comprising generating a melody MIDI based on at least partially on the timing information of the audio selection.

6. The method of claim 1, wherein tone information includes at least one of a genre, a tempo, a mood, an artist, or a style corresponding to the audio selection.

7. The method of claim 1, wherein generating the video content includes automatically selecting at least one of an animation, a graphic, or a visualization based on at least one of the tone information, the lyric information, or the timing information.

8. The method of claim 1, further comprising performing a lyric analysis on the lyric information to determine at least one keyword in the lyric information.

9. The method of claim 8, wherein generating video content includes automatically selecting at least one of an animation, a graphic, or a visualization at least partially based on the lyric analysis.

10. The method of claim 1, further comprising determining, by the one or more processors, a color palette for at least a portion of the lyric video based on the tone information.

11. A computer implemented method for automatically generating lyric videos, the method comprising:
receiving, via a digital communication network, an audio selection;
determining, via one or more processors, timing information of the audio selection;
requesting, via the digital communication network, lyric information of the audio selection from a lyric database;
receiving, via the digital communication network, the lyric information of the audio selection from the lyric database based on the request;
requesting, via the digital communication network, tone information of the audio selection from a tone database;
receiving, via the digital communication network, the tone information of the audio selection from the tone database based on the request, the tone information including at least one of a genre, a tempo, a mood, an artist, or a style corresponding to the audio selection;
generating, via the one or more processors, video content based on at least one of the timing information, the lyric information, and the tone information of the audio selection; and
rendering, via the one or more processors, a lyric video based on the video content and the audio selection.

12. The method of claim 11, wherein requesting the tone information of the audio selection from the tone database includes transmitting a song identification to a third party.

13. The method of claim 11, wherein the timing information of the audio selection is determined from digital sheet music.

14. The method of claim 11, further comprising generating a melody MIDI based on at least partially on the timing information of the audio selection.

15. The method of claim 11, wherein generating the video content includes automatically selecting at least one of an animation, a graphic, or a visualization based on at least one of the tone information, the lyric information, or the timing information.

16. The method of claim 11, further comprising performing a lyric analysis on the lyric information to determine at least one keyword in the lyric information.

17. The method of claim 16, wherein generating video content includes automatically selecting at least one of an animation, a graphic, or a visualization at least partially based on the lyric analysis.

18. The method of claim 11, further comprising determining, by the one or more processors, a color palette for at least a portion of the lyric video based on the tone information.

19. A computer implemented method for automatically generating lyric videos, the method comprising:
receiving, via a digital communication network, an audio selection from a user device;
determining, via one or more processors, timing information of the audio selection;
determining, via the one or more processors, lyric information of the audio selection;
performing, via the one or more processors, a lyric analysis on the lyric information;
requesting, via the digital communication network, tone information of the audio selection from a third party database;
receiving, via the digital communication network, the tone information of the audio selection from the third party database based on the request, the tone information including at least one of a genre, a tempo, a mood, an artist, or a style corresponding to the audio selection;
generating, via the one or more processors, video content based on at least one of the timing information, the lyric analysis, and the tone information of the audio selection;
rendering, via the one or more processors, at least a portion of a lyric video based on the video content and the audio selection; and
transmitting, via the digital communication network, the at least portion of the lyric video to the user device for playback.

20. The method of claim 19, wherein generating the video content includes automatically selecting at least one of an animation, a graphic, or a visualization based on at least one of the tone information, the lyric information, or the timing information.
